(19) United States
(12) Patent Application Publication
(10) Pub. No.: US 2007/0107780 A1
(43) Pub. Date: May 17, 2007

(54) Fluid handling device

(75) Inventors: Christopher J. Bernard, Cheshire, CT (US); Jennifer Zewinski, Vernon, CT (US); Jonathan C. O'Connell, North Haven, CT (US)

Correspondence Address: LOUIS J. WILLE;BRISTOL-MYERS SQUIBB COMPANY, PATENT DEPARTMENT, P O BOX 4000, PRINCETON, NJ, 08543-4000, US

(73) Assignee: Bristol-Myers Squibb Company

(21) Appl. No.: 11/593,275

(22) Filed: Nov. 6, 2006

Related U.S. Application Data
(60) Provisional application No. 60/734,064, filed on Nov. 7, 2005.

(51) Int. Cl. B67C 3/16

(52) U.S. Cl. 137/205

(57) ABSTRACT

A fluid handling device and a method for implementing the fluid handling device is provided, wherein the fluid handling device includes a pressure control device configurable to generate at least one of a positive pressure and a negative pressure; and a flow control device having a flow control device output, wherein the flow control device is configurably associated with the pressure control device such that at least one of the positive pressure and the negative pressure is in flow communication with the flow control device output.

### CROSS-REFERENCE TO RELATED PATENT APPLICATIONS

The present application is related to U.S. Provisional Patent Application No. 60/734,064 filed Nov. 07, 2005, the contents of which are incorporated by reference herein in their entirety.

### FIELD OF THE INVENTION

This disclosure relates generally to the handling of an assay and more particularly to a multi-directional device for handling an assay.

### BACKGROUND OF THE INVENTION

One of the main challenges for pharmaceutical companies in developing cures and treatments for illnesses involves controlling the costs required to develop and process the biological materials, such as proteins, enzymes and cell based assays, needed to create the desired drugs and medicines. Unfortunately however, many of the compounds included in drug screening assays are archival and only available in very limited quantities or they are the products of combinatorial synthesis procedures and thus are only produced in microgram to milligram quantities. As such, a significant effort has been put forth by the pharmaceutical industry to develop methods and devices that would promote conservation of these valuable compounds by increasing assay efficiency to minimize costs. One such method, assay miniaturization, is an immediate and viable route to this objective.

In response to this trend toward assay miniaturization, several types of devices have been developed to process these assays in small quantities. Referring to FIG. 1, one such device is a fluid handling device 100 which was developed to automatically dispense precisely controlled quantities of fluids, such as buffers, reagents and solvents for plate preparation and assay development into assay vials and/or assay plates. Typically, the fluid handling device 100 of FIG. 1, includes a flow controller device 102 connected to a fluid container 104 via a flow tube 106, wherein the fluid container 104 includes a fluid and is further connected to a dispensing device 108 via a dispensing tube 110 for dispensing the fluid into a receiving device, such as an assay vial and/or an assay plate. Referring to FIG. 2, the fluid handling device 100 is typically configurable for use with a plurality of reagents and/or fluid containers 104.

Unfortunately however, current fluid handling devices, such as the fluid handling device 100, include several disadvantages which involve limitations in its fluid handling capabilities. For example, one disadvantage involves the dispensing of a fluid containing suspended matter. When dispensing a fluid containing suspended matter, current fluid handling devices are unable to evenly and consistently dispense the fluid. This is because during periods of inactive dispensing and between periods of active dispensing when the fluid is not flowing through the flow tube(s), a small portion of the fluid is stationary within the flow tube(s). During this stationary period, the suspended matter contained within the fluid tends to ‘settle’ out of the fluid into ‘clumps’ and may actually adhere to the inner walls of the tubing. As such, when active dispensing is again initiated and the fluid begins to flow through the flow tube, the settled matter may cause stratification of the flow or the settled matter may be dispensed as ‘clumps’ as opposed to being dispensed in a controlled and consistent manner. As a result, the matter contained within the fluid tends to be dispensed in groups or “hot spots’ of material. This lack of distribution control is undesirable because the uneven distribution of cells and/or beads can cause results from future processing to be skewed and inaccurate.

Another disadvantage involves the inability of current fluid handling devices to accurately and controllably dispense small volumes of fluids (and hence suspended matter) in several different formats. As a result, approximately only 40% of assays are currently capable of being miniaturized on automated platforms. This lack of miniaturization capability is undesirable because it requires that a majority of assays be processed by hand thus imposing a limitation on the number of assays that are capable of being processed in this manner using automation.

### SUMMARY OF THE INVENTION

A fluid handling device is provided and includes a pressure control device configurable to generate at least one of a positive pressure and a negative pressure and a flow control device having a flow control device output, wherein the flow control device is configurably associated with the pressure control device such that at least one of the positive pressure and the negative pressure is in flow communication with the flow control device output.

A fluid handling device is provided and includes a vacuum generation device, a pressure generation device, a fluid container having a container cavity and a flow controller device, wherein the flow controller device is in flow communication with the pressure generation device, the vacuum generation device and the fluid container and wherein the flow controller device is configurable between a first configuration and a second configuration. When the flow controller device is configured into the first configuration, the pressure generation device is in flow communication with the fluid container and wherein when the flow controller device is configured in the second configuration, the vacuum generation device is in flow communication with the fluid container.

A method for implementing a fluid handling device is provided, wherein the fluid handling device includes a pressure control device configurable to generate at least one of a positive pressure and a negative pressure and a flow control device having a flow control device output, wherein the flow control device is configurably associated with the pressure control device such that at least one of the positive pressure and the negative pressure is in flow communication with the flow control device output. The method includes operating the pressure control device to generate at least one of the positive pressure and the negative pressure and configuring the flow control device such that at least one of the positive pressure and the negative pressure is present at the flow control device output.

### BRIEF DESCRIPTION OF THE DRAWINGS

The foregoing and other features and advantages of the present invention will be more fully understood from the following detailed description of illustrative embodiments, taken in conjunction with the accompanying drawings in which like elements are numbered alike:

FIG. 1 is a schematic block diagram illustrating a fluid handling device, in accordance with the prior art;

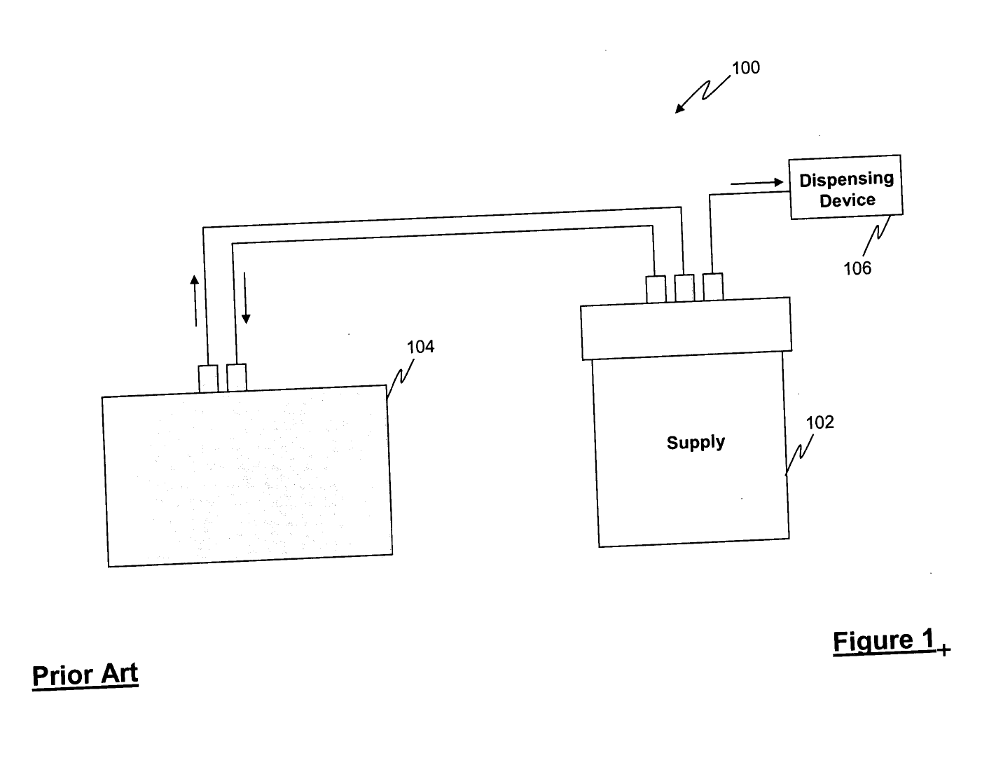

FIG. 2 is a schematic block diagram illustrating a plurality of prior art fluid handling devices in FIG. 1;

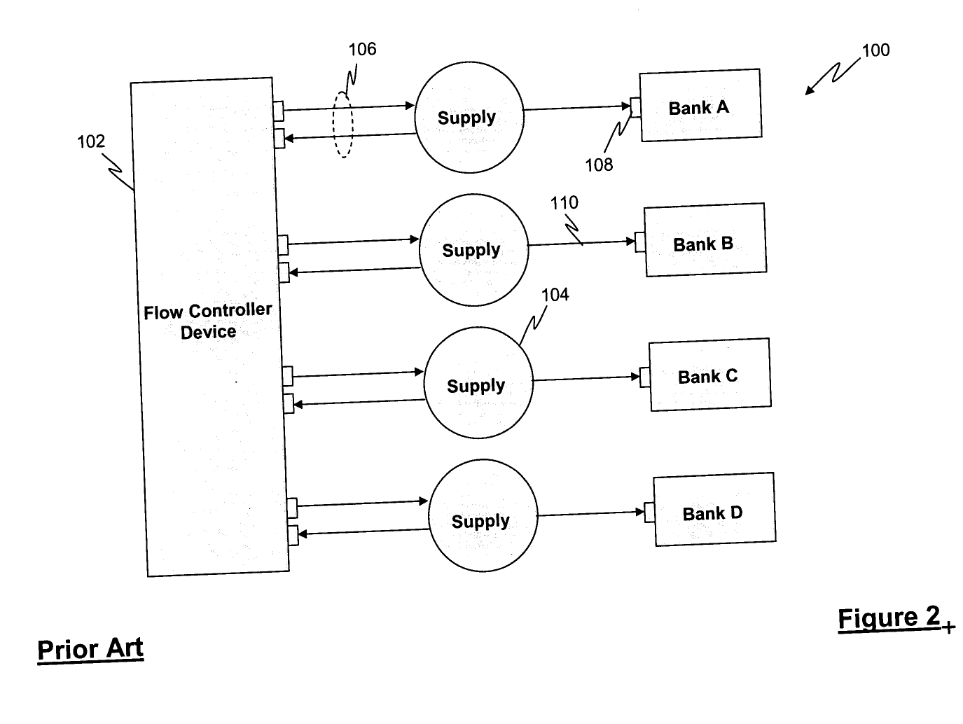

FIG. 3 is a schematic block diagram illustrating one embodiment of a fluid handling device, in accordance with the present invention;

FIG. 4 is a schematic block diagram illustrating one embodiment of a plurality of the fluid handling devices in FIG. 3;

FIG. 5A is a schematic block diagram illustrating the fluid handling device in FIG. 3;

FIG. 5B is a schematic block diagram illustrating the fluid handling device in FIG. 3;

FIG. 6 is a schematic block diagram illustrating an alternative embodiment of a fluid handling device, in accordance with the present invention;

FIG. 7 is a schematic block diagram illustrating the fluid handling device of FIG. 6, in accordance with the present invention;

FIG. 8 is a schematic block diagram illustrating the fluid handling device of FIG. 6, in accordance with the present invention;

FIG. 9 is a schematic block diagram illustrating the fluid handling device of FIG. 6, in accordance with the present invention; and

FIG. 10 is a schematic block diagram illustrating one embodiment of a method for implementing the fluid handling device of FIG. 3.

### DETAILED DESCRIPTION

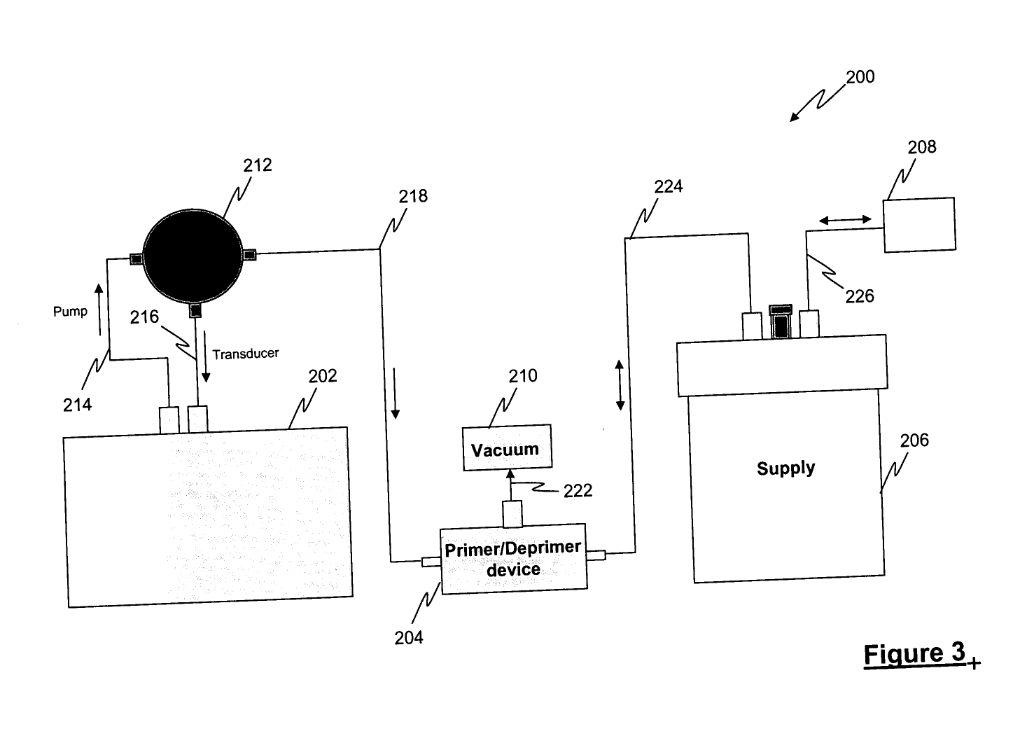

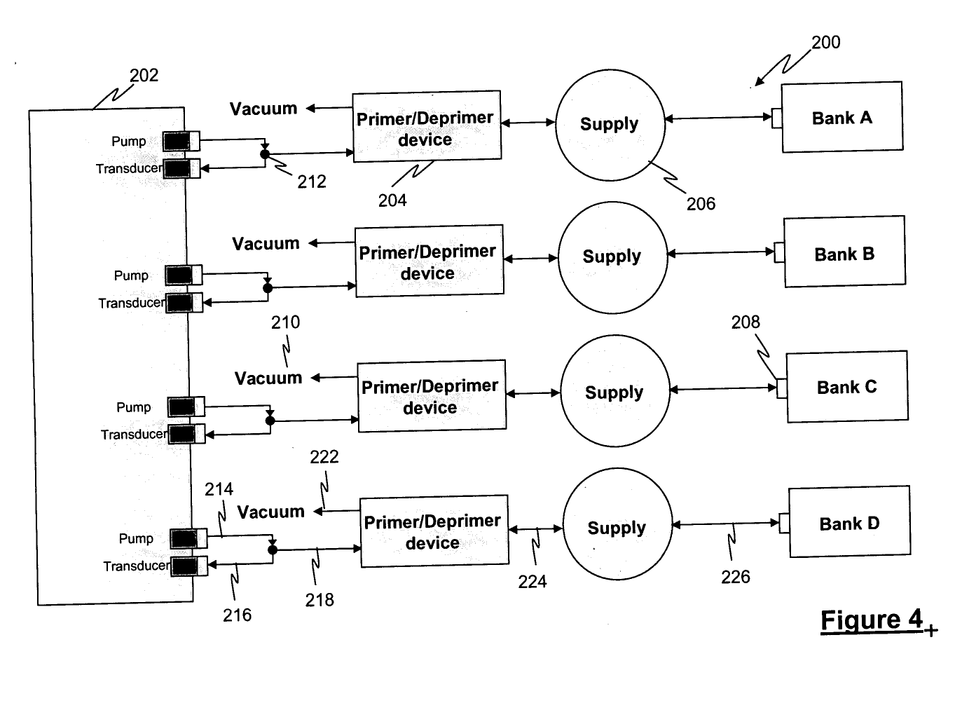

Referring to FIG. 3, a schematic block diagram illustrating one embodiment of a fluid handling device 200 in accordance with the present invention is shown and includes a pressure controller device 202, a primer/deprimer device or flow control device 204, a fluid container 206, a fluid transfer device 208 and a vacuum device 210 (which may be integrated with pressure controller device 202), wherein the pressure controller device 202 is in flow communication with the fluid container 206 via the flow control device 204. The at least one pressure controller device 202 is configured to be in flow communication with a valve 212 via a pressure tube 214 and a pressure monitoring device, such as transducer tube 216, wherein the valve 212 is in further flow communication with the flow control device 204 via a valve tube 218. The flow control device 204 is further communicated with the vacuum device 210 and the fluid container 206 via a vacuum tube 222 and a container flow tube 224, respectively. The fluid container 206 is further in flow communication with the fluid transfer device 208 via a dispensing tube 226 for dispension into at least one assay vial and/or at least one assay plate. Referring to FIG. 4, it should be appreciated that the fluid handling device 200 of FIG. 3 may be configurable to operate with a single fluid container 206 or a plurality of fluid containers 206. Additionally, it should be appreciated that the flow control device 204 may be configurable between a first configuration to allow fluid to flow in one direction and a second configuration to allow fluid to flow in another direction.

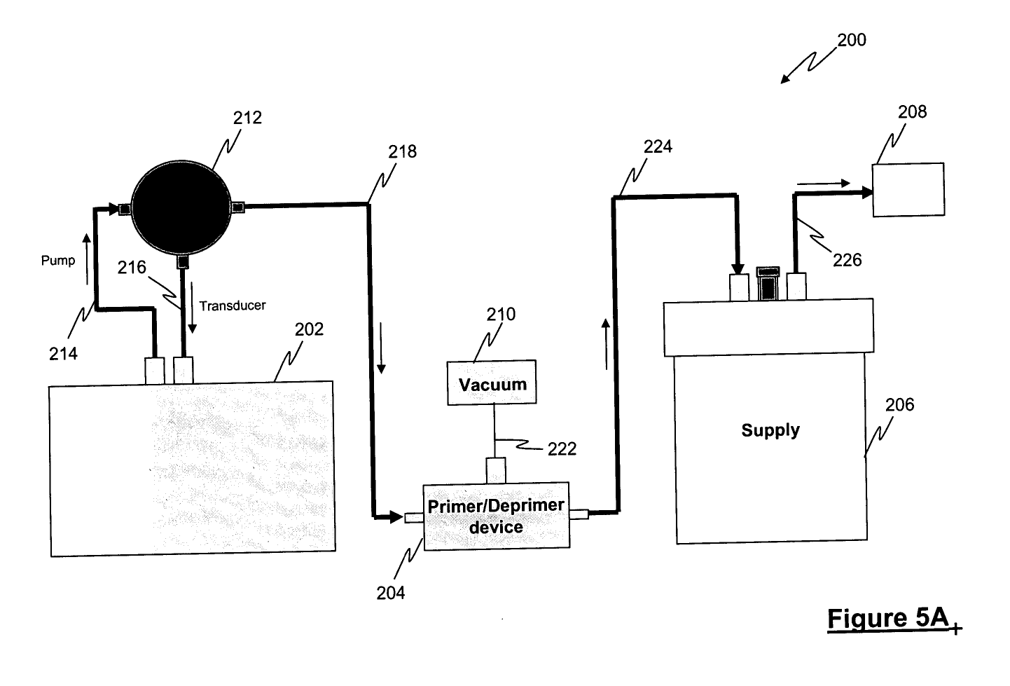

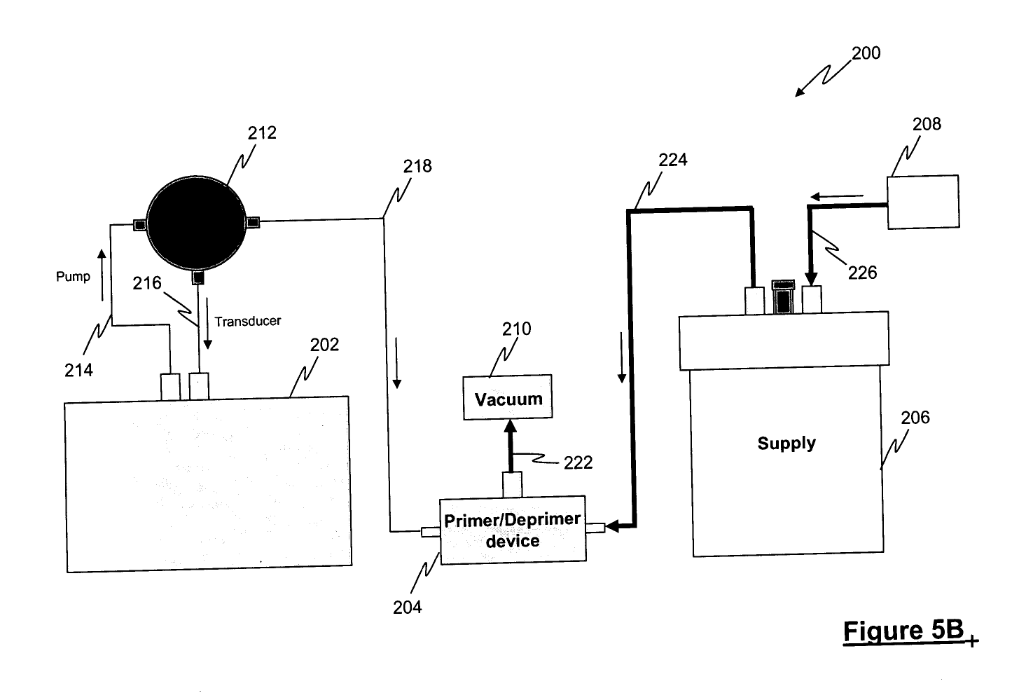

Referring to FIG. 5A, a schematic block diagram 500 illustrating one embodiment of an operational flow for the fluid handling device 200 of FIG. 3 and/or FIG. 4 is shown and includes a pressure controller device 202 that may be operated to generate a pressure within the pressure tube 214 such that the pressure flows through the valve 212, through the valve tube 218, through the flow control device 204, through the container flow tube 224 and into the fluid container 206. This causes the pressure within the fluid container 206 to increase thereby causing the fluid contained within the fluid container 206 to flow into the dispensing tube 226 and into the fluid transfer device 208 for distribution to at least one holding device, such as an assay vial and/or an assay plate. The pressure flowing through the fluid handling device 200 may be monitored and communicated back to the pressure controller device 202 via the transducer 216 which allows the pressure controller device 202 to continuously adjust the pressure to maintain a constant pressure throughout the fluid handling device 200. Additionally, the volume of the fluid being dispensed by the fluid dispenser 208 may be monitored and the pressure controller device 202 may be continuously adjusted to maintain a constant fluid volume out of the fluid transfer device 208.

Referring to FIG. 5B, when the dispensing of the fluid is paused, the flow control device 204 may be configured such that the pressure flow into the flow control device 204 is isolated and the vacuum tube 222 is communicated with the container flow tube 224. The vacuum device 210 may then be operated to cause a vacuum within the vacuum tube 222 thereby generating a vacuum within the container flow tube 224 and thus within the fluid container 206. This vacuum within the fluid container 206 causes any fluid within the dispensing tube 226 to flow out of the dispensing tube 226 and back into the fluid container 206. It should be appreciated that the vacuum within the container flow tube 224 and/or the fluid container 206 may be monitored and adjusted to ensure that the magnitude of the vacuum within the container flow tube 224 and/or the fluid container 206 is not so great that it causes the fluid within the fluid container 206 to flow into the container flow tube 224.

It should be appreciated that the pressure generated from the pressure controller device 202 may be sensed via the transducer tube 216 which may be communicated with the pressure tube 214 via the valve 212. This allows the pressure controller device 202 to make adjustments to the pressure as needed to control the flow of fluid out of the fluid container 206. It should be further appreciated that the fluid handling device 200 of FIG. 3 and FIG. 4, allows for the controllable and precise distribution of a small volume fluid sample from the fluid container 206 into an assay vial and/or an assay plate. It should be further appreciated that the flow control device 204 allows the fluid handling device 200 to pause the dispension of fluids and to configure the dispensing tube 226 such that fluid within the dispensing tube 226 is returned into the fluid container 206 leaving no fluid remaining within the dispensing tube 226. As such, this allows for the controllable and precise distribution of a fluid sample from the fluid container 206 into a holding device, such as an assay vial and/or an assay plate such that any suspended matter within the fluid sample remains suspended within the fluid in a controllable and predictable population distribution.

Additionally, although the fluid handling device 200 is shown as including several devices including a pressure controller device 202, a flow control device 204, a fluid container 206, a fluid transfer device 208 and a vacuum device 210, it is contemplated that any greater and/or lesser number of devices may be used to achieve the same or similar results. Furthermore, it is contemplated that the present invention may be configured to directly and/or indirectly interface and/or integrate with existing fluid handling devices via an in-line configuration and/or an add-on configuration. This would allow existing technologies to be ‘up-graded’ to better control the flow of a fluid, thus allowing for more accurate and better fluid dispension and retention.

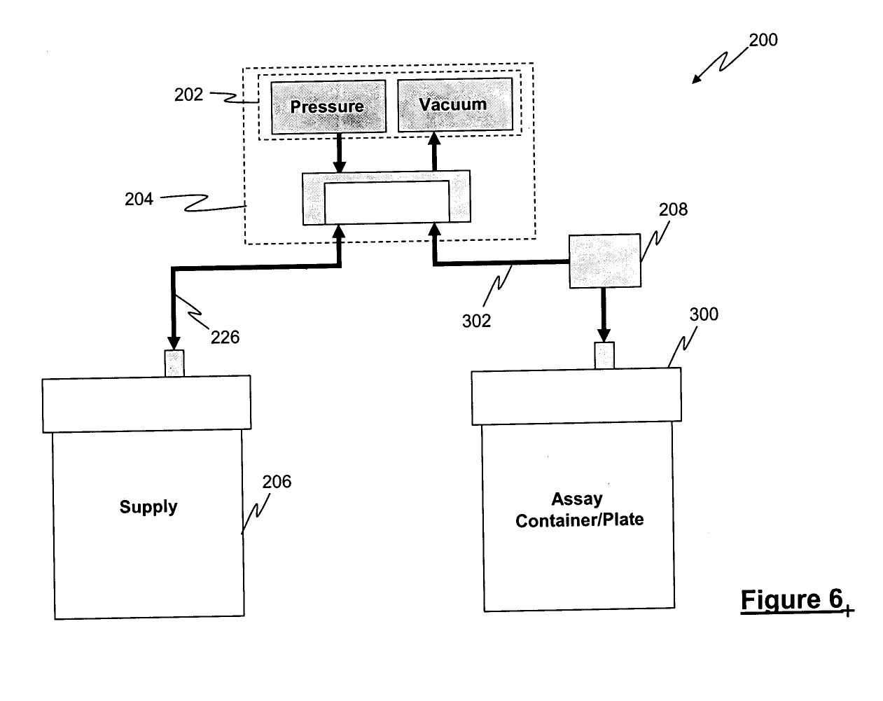

It should also be appreciated that other configurations are also contemplated and are considered to be within the scope of the present invention. For example, referring to FIG. 6, an alternative embodiment of the fluid handling device 200 is shown and includes a pressure control device 202 associated or integrated with the flow control device 204 which is shown as being in flow communication with an assay container/plate 300 via fluid transfer device 208 and an assay tube 302. In this configuration, the fluid flow between the fluid container 206 and the flow control device 204 could be initiated and controlled by selectively and controllably generating a positive pressure and/or a vacuum, or negative pressure, within the dispensing tube 226 and/or the assay tube 302.

Consider the situation where a fluid transfer process has been terminated/paused and a fluid still remains within the dispensing tube 226 and the assay tube 302. To recover the fluid contained in the dispensing tube 226, the pressure control device 202 may generate a positive pressure within the dispensing tube 226 causing the fluid contained therein to flow out of the dispensing tube 226 and into the fluid cavity of the fluid container 206. In a similar fashion, the pressure control device 202 may generate a positive pressure within the assay tube 302 causing the fluid contained therein to flow out of the assay tube 302 and into an assay disposal device. Alternatively, the fluid remaining in the assay tube 302 may be recovered by directing the fluid to flow through the assay tube 302 and into the dispensing tube 226, wherein the fluid may then be dispensed back into the fluid cavity of the fluid container 206 for future use.

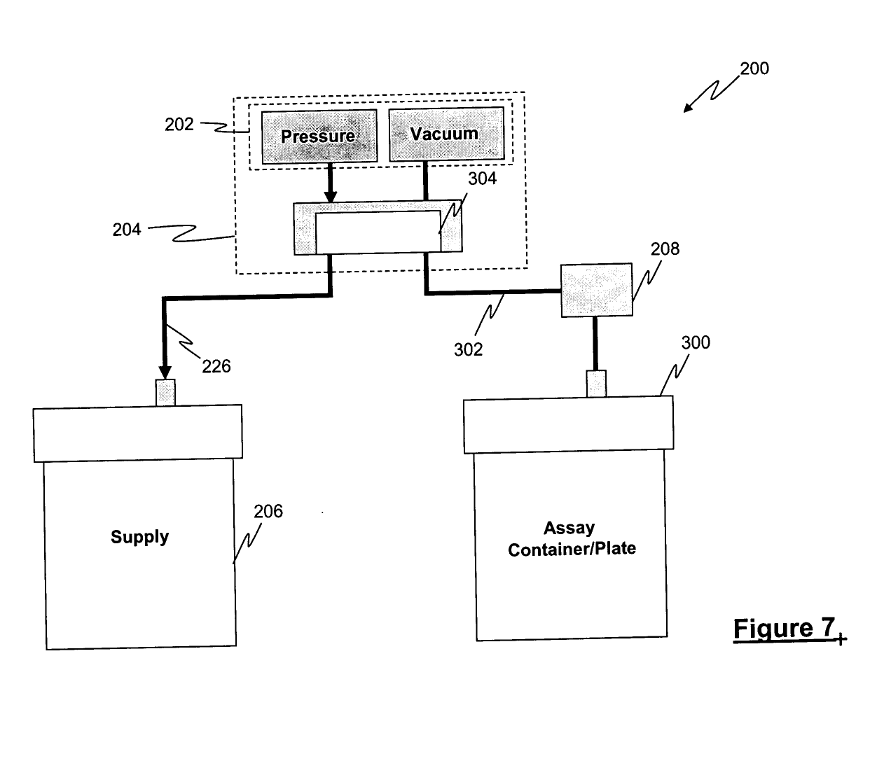

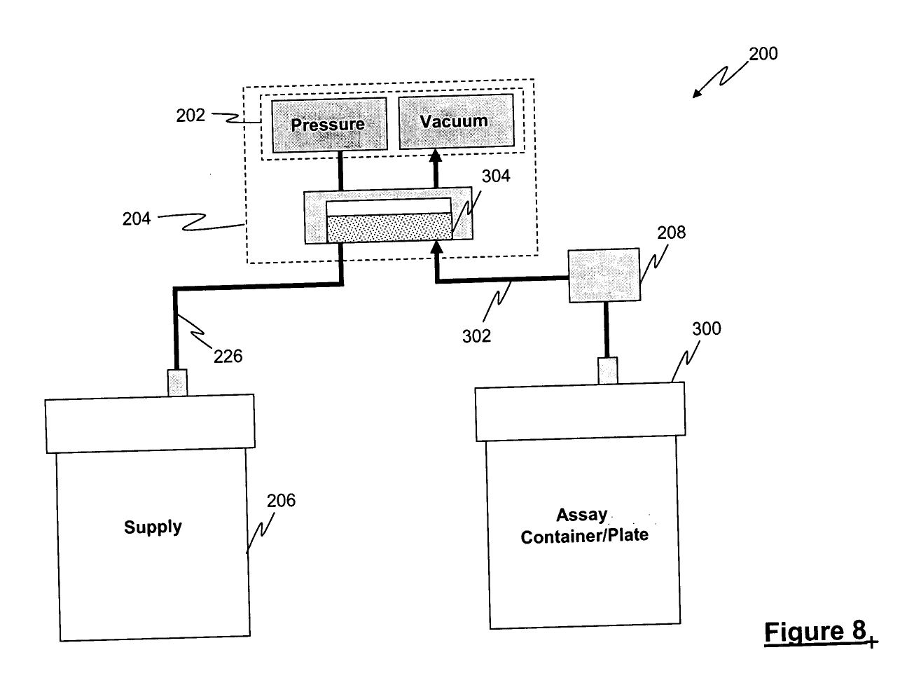

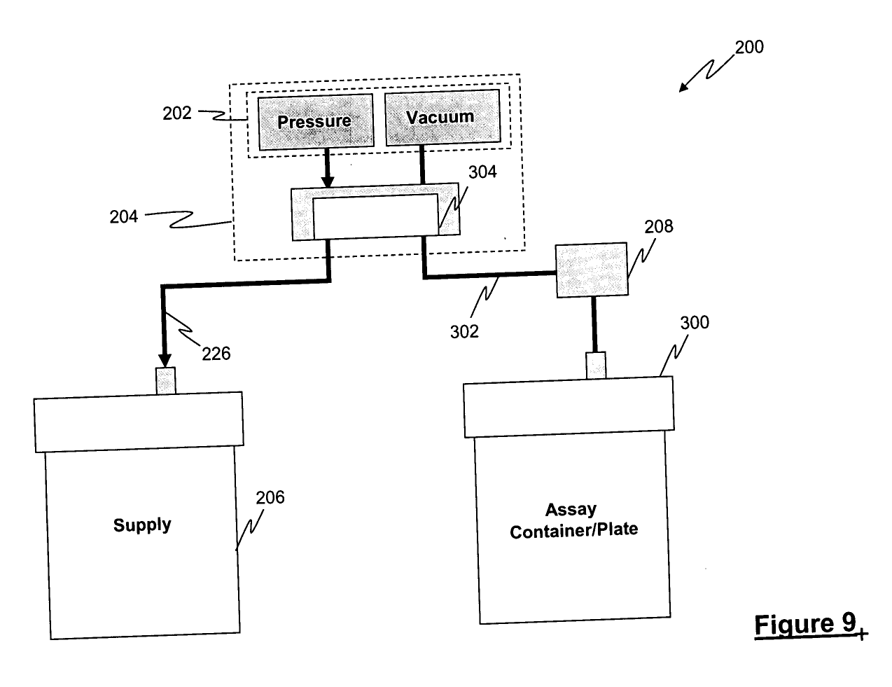

One way to accomplish this would be to have a flow control device 204 that is configured to selectively and controllably isolate the dispensing tube 226 from the assay tube 302. This would allow the flow within the dispensing tube 226 to be controlled independently from the flow within the assay tube 302. For example, if transfer of fluid was interrupted/paused and fluid remained in both the dispensing tube 226 and the assay tube 302, the dispensing tube 226 could be isolated from the assay tube 302. The pressure control device 202 could then be operated to generate a positive pressure within the dispensing tube 226, thereby causing the fluid within the dispensing tube 226 to flow away from the flow control device 204 and back into the fluid container 206, as shown by the arrowed lines in FIG. 7. The pressure control device 202 may be operated to generate a negative pressure within the assay tube 302, thereby causing the fluid within the assay tube 302 to flow through the assay tube 302 toward the flow control device 204, wherein the recovered fluid could then be contained within an isolated cavity 304 that may be disposed external or internal to the flow control device 204, as shown by the arrowed lines in FIG. 8. When the assay tube 302 is evacuated of fluid, the pressure control device 202 may then be operated to generate a positive pressure causing the recovered fluid to flow out of the isolated cavity 304, through the dispensing tube 226 and back into the fluid container 206, as shown by the arrowed lines in FIG. 9.

It should be appreciated that although the fluid handling device 200 described herein includes a pressure control device 202 for controlling the flow fluid, any fluid flow control device and/or method suitable to the desired end purpose, such as electric and gas flow devices, may be used. Additionally, although the pressure control device 202 is shown as having a vacuum generation device and a pressure generation device, any atmosphere generation device suitable to the desired end purpose, such as a positive pressure/vacuum/negative pressure generation device, may be used. Furthermore, it is contemplated that the pressure within each of the components (i.e. container cavity, dispensing tube 226, assay tube 302 . . . ) throughout the fluid handling device may be monitored, collectively or individually, wherein each of the components (i.e. pressure control device 202 and/or flow control device 204) the fluid handling device 200 may be operated, collectively or individually, responsive to obtained pressure levels.

Moreover, it is also contemplated that the present invention can be used for recovery or aspiration of fluids within an external device, such as an assay plate. For example, to recovery fluid disposed in or on an external device, the fluid transfer device 208 may include a pipette (which may be connected to the dispensing tube 226 via the fluid transfer device 208) disposed to be in contact with the fluid. The pressure control device 202 and flow control device 204 are configured such that a vacuum or negative pressure is present in the dispensing tube 226 and hence at the pipette. This vacuum causes the fluid to be recovered to flow into the pipette, through the dispensing tube 226 and into the fluid container 206. It should be appreciated that, regardless of terminology used, it is contemplated that each and every element of the fluid handling device 200 is bi-directional and allows for the controlled transfer of fluids into and/or out of the fluid handling device 200. Moreover, the present invention may be expanded to accommodate multiple fluid dispension/recovery stations.

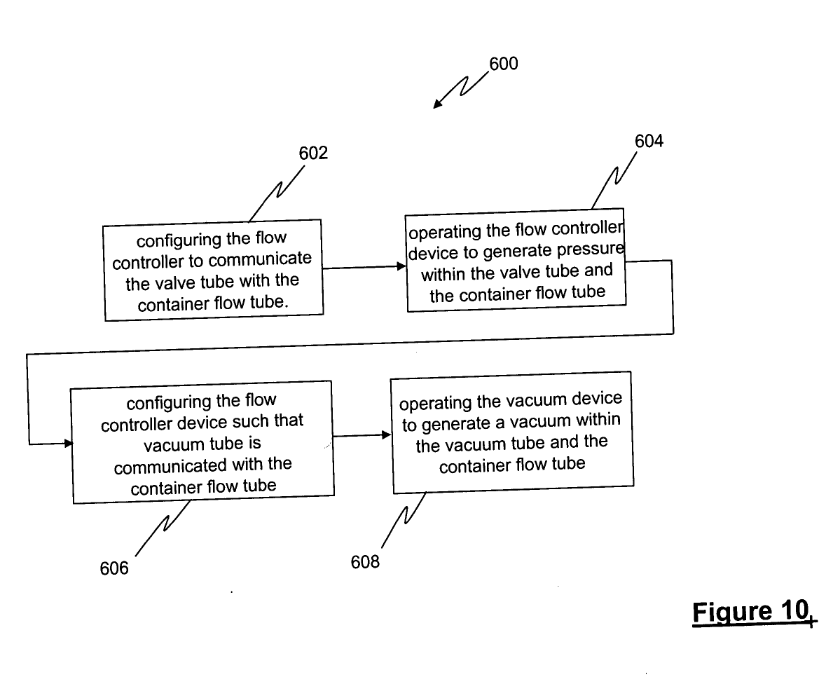

Referring to FIG. 10, a block diagram illustrating one embodiment of a method 600 for implementing the fluid handling device 200 is shown and includes operating the flow control device 204 such that the valve tube 218 is in flow communication with the container flow tube 224, as shown in operational block 602. The pressure controller device 202 is configured to generate a predetermined amount of pressure within the valve tube 218, as shown in operational block 604, to cause the pressure within the fluid container 206 to increase to a desired pressure level. It should be appreciated that the desired pressure level may be configured responsive to the desired flow rate of the fluid out of the fluid container 206 and through the dispensing tube 226. During downtimes of the fluid handling device 200 and/or during pauses in fluid flow through the dispensing tube 226, the flow control device 204 may be configured to communicate the vacuum tube 222 with the container flow tube 224, as shown in operational block 606. The vacuum device 210 may then be operated to generate a vacuum within the vacuum tube 222 thereby creating a vacuum within the container flow tube 224 and thus, within the fluid container 206, as shown in operational block 608. This causes any fluid contained within the dispensing tube 226 to flow out of the dispensing tube 226 and back into the fluid container 206 preventing any settlement, adherence and/or ‘clumping’ of material suspended in the fluid.

In accordance with an exemplary embodiment, processing of the method in FIG. 10, in whole or in part, may be implemented through a processing device operating in response to a computer program which may have a Graphical User Interface for user controlled operation or which may be automatic. In order to perform the prescribed functions and desired processing, as well as the computations therefore (e.g., the execution of fourier analysis algorithm(s), the control processes prescribed herein, and the like), the controller may include, but not be limited to, a processor(s), computer(s), memory, storage, register(s), timing, interrupt(s), communication interfaces, and input/output signal interfaces, as well as combinations comprising at least one of the foregoing. For example, the controller may include signal input signal filtering to enable accurate sampling and conversion or acquisitions of such signals from communications interfaces. It is also considered within the scope of the invention that the processing of the method of FIG. 10, in whole or in part, may be implemented by a controller located remotely from the processing device.

Moreover, in accordance with an exemplary embodiment, the above embodiment(s) can be embodied in the form of computer-implemented processes and apparatuses for practicing those processes. The above can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Existing systems having reprogrammable storage (e.g., flash memory) can be updated to implement the invention. The above can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to an exemplary embodiment, it should be understood by those skilled in the art that various changes may be made and equivalents may be substituted for elements thereof without departing from the scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

We claim:

1. A fluid handling device, comprising:
a pressure control device configurable to generate at least one of a positive pressure and a negative pressure; and
a flow control device having a flow control device output, wherein said flow control device is configurably associated with said pressure control device such that at least one of said positive pressure and said negative pressure is in flow communication with said flow control device output.

2. The fluid handling device of claim 1, wherein said pressure control device includes a pressure generation device for generating said positive pressure, wherein said pressure generation device is in flow communication with said flow control device via at least one pressure tube.

3. The fluid handling device of claim 1, wherein said pressure control device includes a vacuum generation device for generating said negative pressure, wherein said vacuum generation device is in flow communication with said flow control device via at least one vacuum tube.

4. The fluid handling device of claim 1, wherein said pressure control device is in flow communication with said flow control device via at least one flow tube.

5. The fluid handling device of claim 4, further comprising a pressure monitoring device for monitoring pressure level in at least one of said at least one flow tube and said flow control device output, wherein at least one of said pressure control device and said flow control device is configurable responsive to said pressure level.

6. The fluid handling device of claim 1, wherein said flow control device output is in flow communication with a fluid container via a container flow tube, wherein said fluid container includes a fluid cavity for containing a fluid.

7. The fluid handling device of claim 6, wherein said fluid cavity is sealed such that when said negative pressure is present at said flow control device output, a vacuum is present in said fluid cavity and wherein when said positive pressure is present at said flow control device output, a positive pressure is present in said fluid cavity.

8. The fluid handling device of claim 6, further comprising a pressure monitoring device configured to measuring a pressure level within said fluid cavity, wherein at least one of said pressure control device and said flow control device is configurable responsive to said pressure level.

9. The fluid handling device of claim 6, wherein said fluid container further includes a fluid transfer device in flow communication with said fluid cavity via at least one of a dispensing tube and an assay tube.

10. The fluid handling device of claim 9, wherein when said positive pressure is present in said fluid cavity, fluid disposed within said dispensing tube flows through said dispensing tube away from said fluid cavity.

11. The fluid handling device of claim 9, wherein when said negative pressure is present in said fluid cavity, fluid disposed within said dispensing tube flows through said dispensing tube toward said fluid cavity.

12. The fluid handling device of claim 6, further comprising a fluid transfer device in flow communication with said fluid cavity via a dispensing tube, wherein said fluid transfer device is configured to controllably dispense a fluid contained with said fluid cavity.

13. A fluid handling device, comprising:
a vacuum generation device;
a pressure generation device;
a fluid container having a container cavity; and
a flow controller device, wherein said flow controller device is in flow communication with said pressure generation device, said vacuum generation device and said fluid container and wherein said flow controller device is configurable between a first configuration and a second configuration, wherein when said flow controller device is configured into said first configuration, said pressure generation device is in flow communication with said fluid container and wherein when said flow controller device is configured in said second configuration, said vacuum generation device is in flow communication with said fluid container.

14. The fluid handling device of claim 13, wherein when said pressure generation device is in flow communication with said fluid container, a positive pressure is present within said container cavity and wherein when said vacuum generation device is in flow communication with said fluid container a vacuum is present within said fluid container.

15. A method for implementing a fluid handling device having a pressure control device configurable to generate at least one of a positive pressure and a negative pressure and a flow control device having a flow control device output, wherein the flow control device is configurably associated with the pressure control device such that at least one of the positive pressure and the negative pressure is in flow communication with the flow control device output, the method comprising:
operating the pressure control device to generate at least one of the positive pressure and the negative pressure;
configuring the flow control device such that at least one of the positive pressure and the negative pressure is present at the flow control device output.

16. The method of claim 15, further comprising monitoring a pressure level generated by the pressure control device and operably configuring at least one of the pressure control device and the flow control device responsive to said pressure level.

17. The method of claim 15, further comprising associating the flow control device output with a fluid container having a container cavity, wherein said container cavity is in flow communication with a fluid transfer device via a dispensing tube.

18. The method of claim 17, wherein said operating the pressure control device includes generating a positive pressure within said container cavity to cause a fluid contained within said container cavity to flow out of said container cavity and through said dispensing tube toward said fluid transfer device.

19. The method of claim 18, wherein said operating the pressure control device includes generating a negative pressure within said container cavity to cause a fluid contained within at least one of said fluid transfer device and said dispensing tube to flow through said dispensing tube into said container cavity.

20. The method of claim 15, wherein said configuring includes,
associating the flow control device output with an external fluid, and
configuring the flow control device such that a negative pressure is present at the flow control device output, such that said external fluid flows through said dispensing tube.
